(19) United States
(12) Patent Application Publication
(10) Pub. No.: US 2014/0202551 A1
(43) Pub. Date: Jul. 24, 2014

(54) MOBILE FLUID DISPENSING APPARATUS, SYSTEM, AND METHOD OF USE THEREOF.

(71) Applicant: THEODORE ALEXANDER HAHN, CLIFTON PARK, NY (US)

(72) Inventor: THEODORE ALEXANDER HAHN, CLIFTON PARK, NY (US)

(21) Appl. No.: 13/746,059

(22) Filed: Jan. 21, 2013

(51) Int. Cl. F16K 51/00

(52) U.S. Cl. CPC F16K 51/00
USPC 137/15.01; 137/315.01

(57) ABSTRACT

A mobile fluid dispensing apparatus is shown comprising of a mobile part, a complimentary part, where the mobile part has a means for fluid exchange between the mobile part and the complimentary part. The mobile part is configured to engage with the complimentary part to form a fluid connection between them when the mobile part is moved in relation to the complimentary part.

### FIELD OF TECHNOLOGY

The following relates to embodiments of a mobile fluid dispensing apparatus, system, and method of use, and more specifically to embodiments of a mobile cleaning station.

### BACKGROUND

Traditionally, mobile fluid dispensers have been used in various industries. Mobile fluid dispensers in the form of cleaning stations where the mobile stations are on wheels have been seen. They are moved to a location which has some sort of flexible tubes or pipes. A user then with the help of tools and other gadgets installs these flexible tubes or pipes to the mobile station. After the desired work is performed, the user then uninstalls the tubes by, yet again using tools, for unscrewing or similar actions and then moves the station away from the site as desired.

It is clear that this entire process of installing and uninstalling a mobile fluid dispenser can be very tedious, time consuming, and boring. It will also require a person to be trained to use tools and fittings. The old methods of handling the connectors caused waste of time, spillage of fluids, and even wrong connections to be made.

Thus, there is a need for a mobile part to be simply moved into place and connected while moving the mobile part or station in relation to its complimentary part of the apparatus. The embodiments described herein increase the work efficiency of users because there is no waste of time in making connections. Furthermore, spillage of fluids is also controlled, prevented, or avoided.

### SUMMARY

A first aspect relates generally to a mobile fluid dispensing apparatus comprising a mobile part having a fluid exchange means for facilitating a fluid connection between the mobile part and a complimentary part, wherein the mobile part includes an actuator for actuating an actuated of the complimentary part, wherein the fluid connection is established when the mobile part engages the complimentary part through movement of the mobile part in relation to the complimentary part, wherein once the fluid connection is established, the actuator is moved from a first position to a second position to move a valve of the complimentary part to a closed position to an open position to allow a flow of fluid through the mobile part.

A second aspect relates generally to a method of dispensing fluid with a mobile fluid dispensing apparatus comprising providing a mobile part, a complimentary part, and a fluid exchange means for facilitating a fluid connection between the mobile part and the complimentary part, and engaging the mobile part with the complimentary part to form a fluid connection between the mobile part and the complimentary part through movement of the mobile part in relation to the complimentary part.

A third aspect relates generally to a mobile fluid dispensing system comprising a mobile part, a complimentary part, and a fluid exchange means for facilitating a fluid connection between the mobile part and the complimentary part, wherein the fluid connection is established when the mobile part engages the complimentary part through movement of the mobile part in relation to the complimentary part.

The foregoing and other features of construction and operation will be more readily understood and fully appreciated from the following detailed disclosure, taken in conjunction with accompanying drawings.

### BRIEF DESCRIPTION

Some of the embodiments will be described in detail, with reference to the following figures, wherein like designations denote like members, wherein:

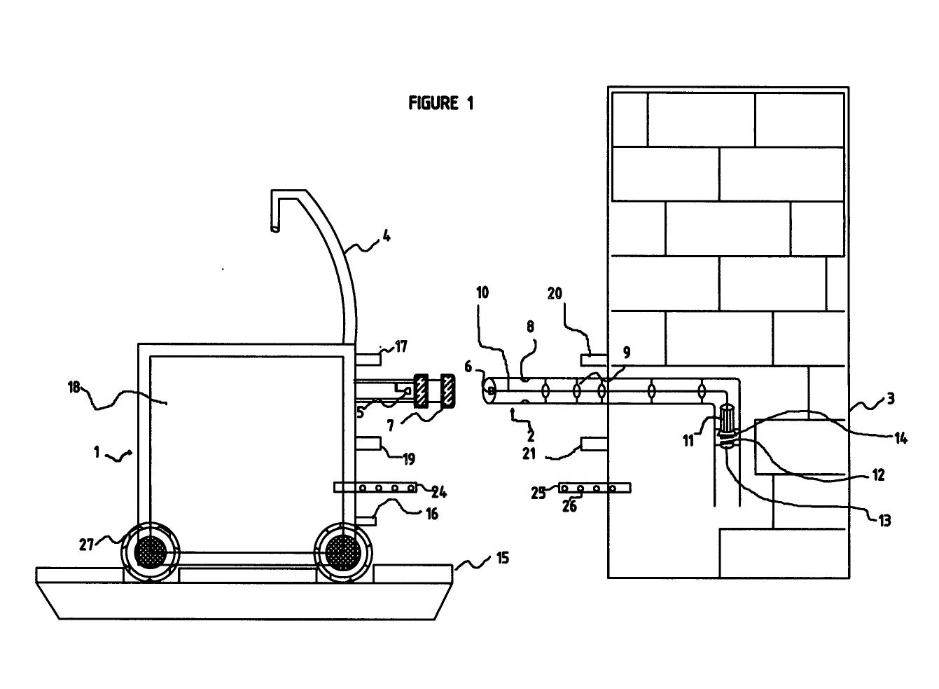

FIG. 1 depicts a side view of an embodiment of a mobile fluid dispensing apparatus with the mobile part uncoupled from the complimentary part;

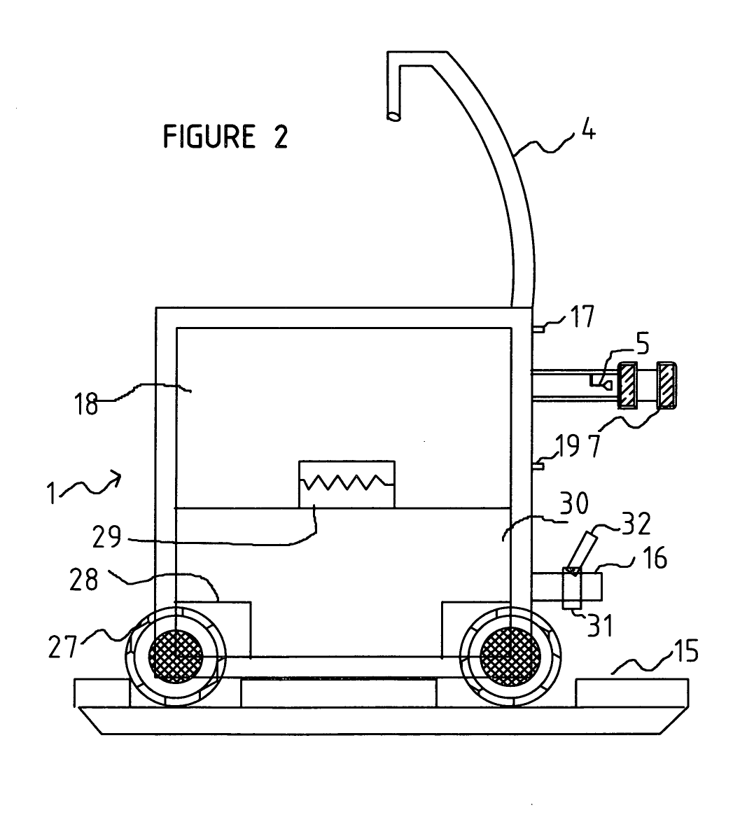

FIG. 2 depicts a side view of an embodiment of the mobile part of a mobile fluid dispensing apparatus where the wheels of the mobile part are situated in a track. The track shows cutouts to show the position of the wheels;

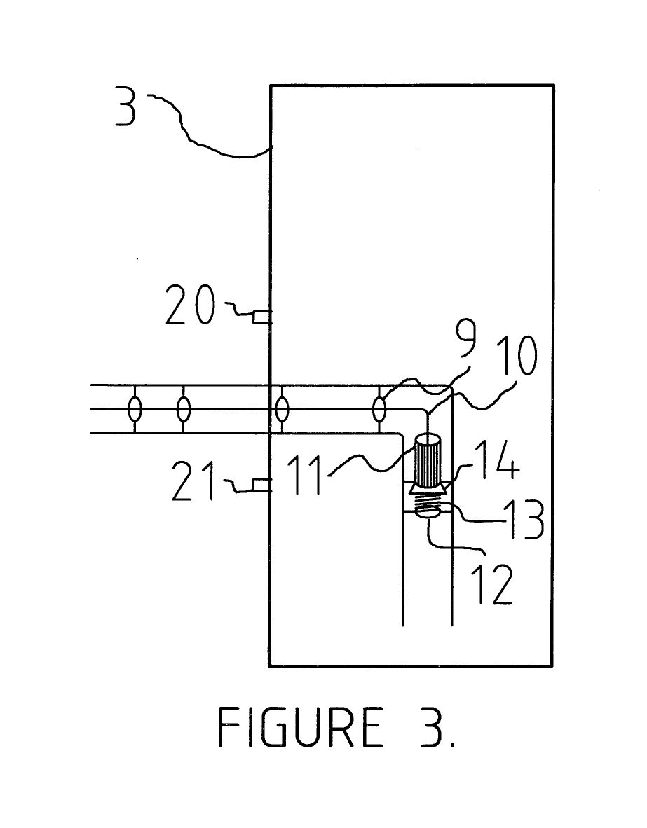

FIG. 3 is a side view of an embodiment of the complimentary part of a mobile fluid dispensing apparatus, depicting the valve, spring, seat, and sensors on the complimentary part;

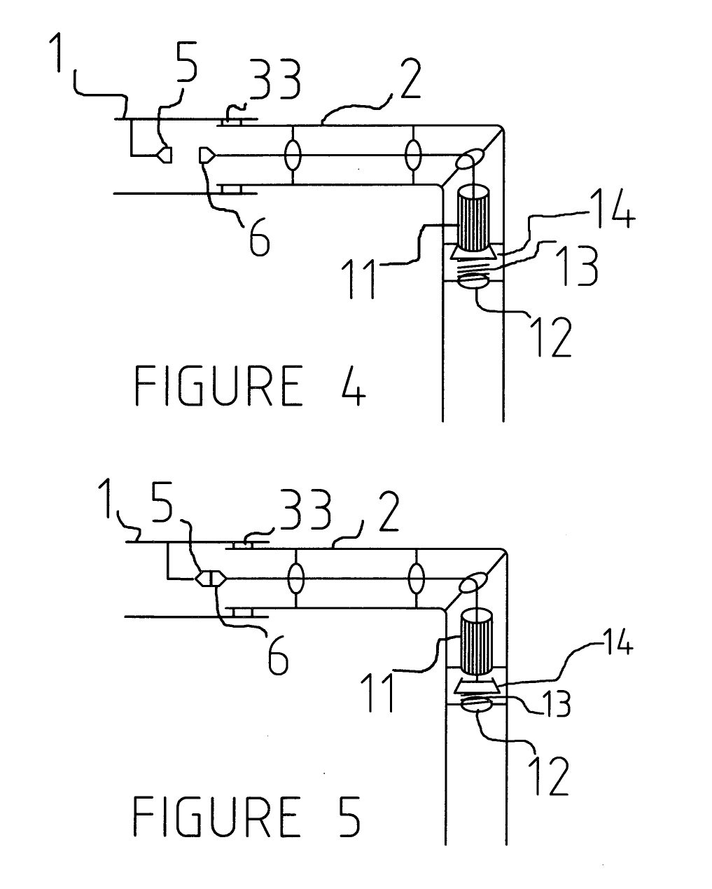

FIG. 4 is a side view of an embodiment of the complimentary part of the mobile fluid dispensing apparatus showing the valve in the closed position;

FIG. 5 is a side view of an embodiment of the complimentary part of the mobile fluid dispensing apparatus showing the valve in the open position;

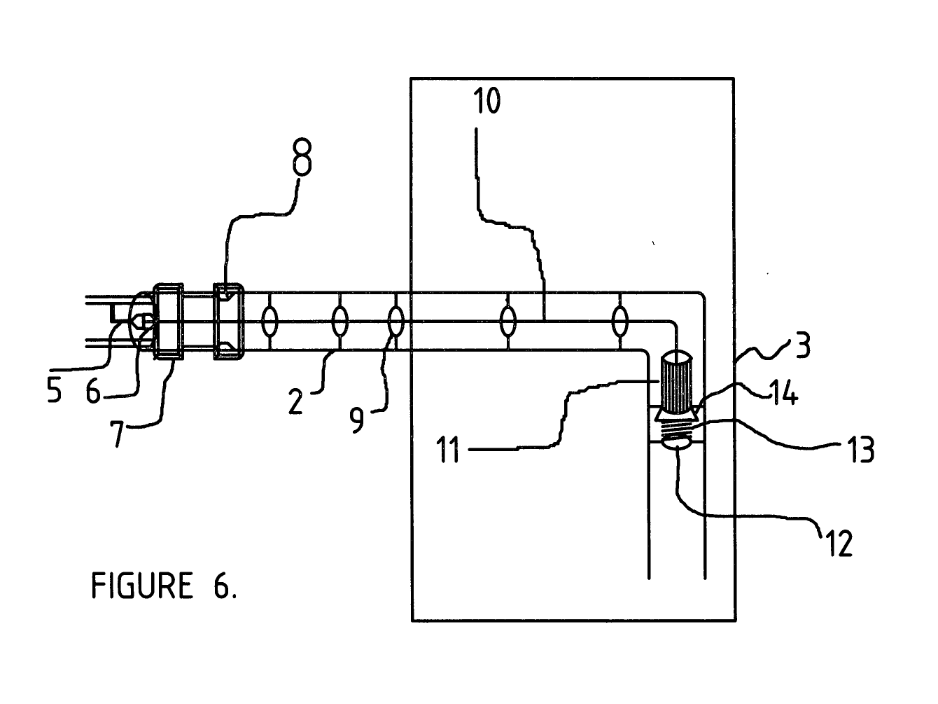

FIG. 6 is a side view of an embodiment of a mobile fluid dispensing apparatus with the mobile part coupled to the complimentary part, with the valve closed;

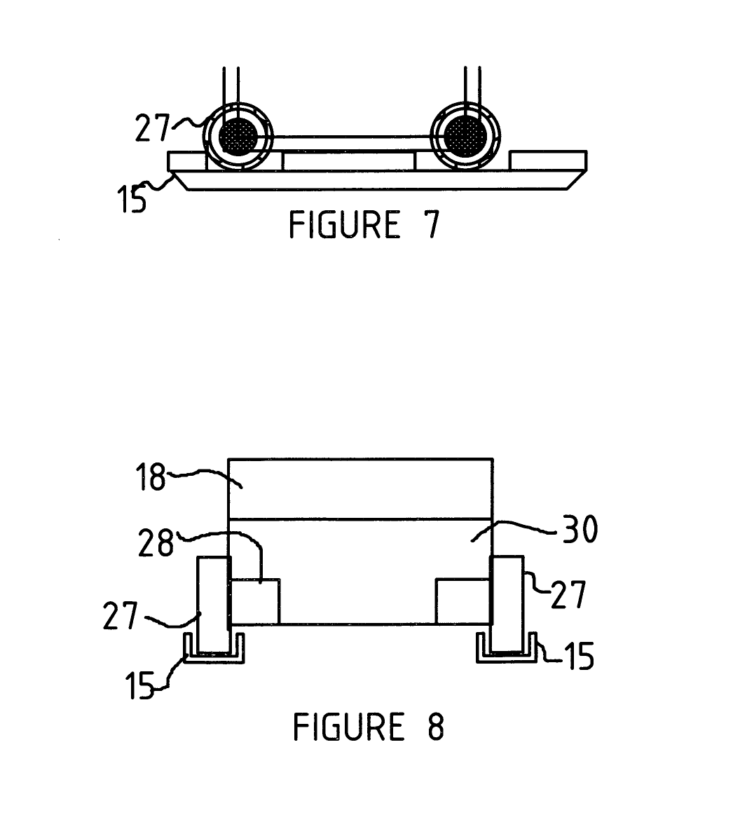

FIG. 7 is a side view of an embodiment of the mobile part of a mobile fluid dispensing apparatus depicting the wheels on the mobile part situated in a track; and

FIG. 8 is a cross section view of the wheels and the mechanical drive on the mobile part of a mobile fluid dispensing apparatus situated in a track.

### DETAILED DESCRIPTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

The following description is presented to enable a person skilled in the art to make and use the embodiments of the present disclosure. Various modifications to the illustrated embodiments will be readily apparent to those skilled in the art, and the generic principles herein may be applied to other embodiments and applications without departing from the present disclosure and its teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments as presented here allow users, for example, to reduce the unproductive time or lag in production they experience when changing or moving a mobile fluid dispensing apparatus, a mobile cleaning system or mobile station. Using the embodiments as shown in the disclosure will cause a significant boost in efficiency for users who have many different products or materials to handle in their mobile fluid dispensing apparatus or cleaning systems. For example, a person may desire to wash produce with water, soak the produce, and then let it dry, before finally cooking/frying the produce. This can be achieved by using one of the embodiments according to the present disclosure as described herein. In the instant example, a mobile part 1 and a complimentary part 2 are shown in FIG. 1. The mobile part 1 may have a dispensing means 4, a cavity 18, a wheel 27 or a plurality thereof for mobility, and a drain apparatus 16 as shown in FIG. 1. Alternate embodiments of the cavity 18 may be a trough, washing area, washing surface, void, sieve, and the like.

As shown in FIG. 2, the drain apparatus 16 may have a drain valve 31 and a valve lever 32. Valve lever 32 may be operated by foot by one using the mobile fluid dispensing apparatus. Alternate embodiments of drain valve 31 may be a ball cock, ball valve, pinch valve, screw type valve, butterfly valve, electronic valve, magnetic valve, self timer valve, and the like. The wheel 27 or a plurality thereof may be situated in a track 15, or a plurality thereof, as shown in FIGS. 7 and 8, for maintaining or limiting the movement of the mobile part 1 in a particular direction. Alternate embodiments of the drain apparatus 16 may be of any commonly known type such as a tap, ball cock, valve, pinch cock, and the like. Alternate embodiments of the dispensing means 4 may be a faucet, rigid or flexible ducts, wands, elastic conduits, and the like. In the instant embodiment of the disclosure, the mobile part 1 has a fluid exchange means 7, which may be used to form a fluid connection between the mobile part 1 and the complimentary part 2. The complimentary part 2 may have a groove 8 for the fluid exchange means to lock into. Alternatively, the grove 8 may be used to hold an o-ring for a tight seal. The fluid connection is described in more detail in the following paragraphs. Once a fluid connection between the mobile part 1 and its complimentary part 2 is made, as shown in FIG. 6, a person may partly fill the cavity 18 in the mobile part 1 with produce and use the dispensing means 4 on the mobile part 1 to dispense water and wash the produce. After washing the produce, the user may fill the cavity 18 with some water and let the produce soak in it. The mobile part 1 may then be moved away to a designated area such as a sewer area, where the drain apparatus 16 may be opened to drain the water. The mobile part 1 may then be connected to another complimentary part 2 which blows air. The dispensing means may be used, in this case, to dry the produce. The person may use a flexible wand attached to the mobile part 1 to blow air on the produce. This time the fluid connection is made for exchanging air between the mobile part 1 and complimentary part 2. Later, the same mobile part 1 can then be moved to another complimentary part 2, this time supplying oil to the station. As depicted in FIG. 2, the mobile part 1 may be fitted with a heat source 29 within the cavity 18. Embodiments of the heat source may be an electric heater, gas burner, solar powered heating element, and the like. The heat source 29 may be used to heat the oil and cook the produce in the oil. As can be seen, changing the stations is quick and easy. No skilled technicians are needed to perform this simple task. An operator may simply use his vision to align the mobile part 1 and complimentary part 2.

It will also be clear to one skilled in the art that a single complimentary part 2 may in turn be connected to a system of vessels which may supply or carry fluid materials to or from it. Fluid materials may be liquids, gases, or solids, based on particle size or dispersion methods and mediums used or a combination of all states of matter and methods. These materials may be carried to or from the mobile part 1 after a fluid connection is made between the mobile part 1 and the complimentary part 2. It will be appreciated by one skilled in the art that a complimentary part 2 may be supplied with different kinds of materials based on the requirements.

An alternate embodiment of the mobile part 1 as per the present disclosure may be a mobile part 1, which may be used in multiples, and several cleaning stations may be employed at a site at one time. Furthermore, same or different materials may be carried through the fluid connections as per requirements. The fluid connections and connectors used may be configured so that they are of standard dimensions and spatial locations, so as to allow any mobile part 1 to be coupled to any complimentary part 2. A complimentary part 2 may be of a fixed nature. One of the embodiments of the present disclosure provides a quick way to change a cleaning station and thus in turn change the materials exchanged between a particular mobile part 1 and a particular complimentary part 2. For example, an item may need cleaning with water, followed by soapy solution and then with water again. This can be achieved by connecting the mobile part 1 with a first complimentary part 2 dispensing water, then with a second complimentary part 2 dispensing soapy solution, and then to a third complimentary part 2 dispensing water, or to the first complimentary part 2, dispensing water. It may also be possible to change the materials in the complimentary part 2, by toggling supply lines, for more than one material at a time without disconnecting the mobile part 1 at that instant. Once a certain purpose is served, the mobile part 1 may then be disconnected from one complimentary part 2 and connected to another complimentary part 2 for a different set of fluids. Whatever the case may be, the mobile part 1 will make connecting and disconnecting an easy operation.

It may also be possible to disconnect the mobile part 1 and move it to a location where any items or dispensed materials may be transferred for further handling or processing.

In many industries, the flexibility of the system as per the present disclosure will allow draining contents of the mobile part 1 into separate drains. This would be necessary where drained materials would not be allowed to drain in a common drainage system because of technical, environmental, recycling, chemical incompatibility, or any other reason.

Alternative embodiments of mobile part 1 may be a cleaning station, household appliance, or a motor which needs a connection for fuel supply, and the like. The means for fluid exchange between the mobile part 1 and the complimentary part 2 may be inlets, outlets, pieces of pipes, or plumbing emerging from the mobile part 1 and the complimentary part 2, and the like. The means may also be specially designed parts which can act attach together. Such specially designed parts may be flanges, concentrically fitting pipes with fluid seals, fitting cones, and the like. Fluid sealing structures such as O-rings, oil seals, or rubber bands, may be held in place by grooves. For example, the outlet 22 on the complimentary part 2 may have a groove 8 to hold an o-ring within the groove 8. As depicted in FIGS. 4 and 5, a fluid seal 33 may alternatively be used without any groove on the complimentary part 2. The outlet 23 of the mobile part 1 may just fit concentrically around the outlet 22 of the complimentary part 2 and slide along the fluid seal 33 within the complimentary part 2. The fluid seal 33 can prevent leakage of fluid once the fluid connection between the mobile part 1 and the complimentary part 2 is achieved. Once this fluid seal fluid connection is made, any fluid flowing between the mobile part 1 and the complimentary part 2 will not leak out from the fluid connection. The fluid seal connection set up can be alternated with between the mobile part 1 and the complimentary part 2. That is, as shown in FIG. 1, the outlet 22 of the complimentary part 2 may have a groove 8, where a fluid seal such as an o-ring may be installed in the groove 8, and the outlet 23 of the mobile part 1 may slide over the outlet 22 of the complimentary part 2 and also over the o-ring held in the groove 8.

Alternative embodiments can provide for varying structures to handle varying amounts of sizes and materials. It might be possible that the system were a “scaled up” version of the system and could be implemented to handle extra functions and/or materials.

The means for fluid exchange as stated above may be a fluid exchange means 7 to allow a connection between the mobile part 1 and the complimentary part 2. Alternate embodiments of the fluid exchange means 7 may be a threaded structure, ball and spring type quick connect, connectors used in garden hoses, clamp, pinch cock, hooks and loops, adhesive, cohesive, abutting, gravity assisted, concentric pipes and o-ring set up, garter spring, fluid seal, type of connection may be used. As will be readily understood by a person skilled in the art, the fluid exchange means 7 may have multiple parts. For example the fluid exchange 7 means may have a male and female part which lock into each other when or while a connection is made. The mobile part 1 may have either the male or female part, and likewise, the complimentary part 2 may have male or female part. It should be further understood that if the mobile part 1 has the male part, then the complimentary part 2 will have the female part, and vice versa. In the most common scenario, the connection between the mobile part 1 and complimentary part 2 may be achieved by moving the mobile part 1 towards the complimentary part 2 so as to engage the fluid exchange means 7. In other scenarios, the mobile part 1 may have to be moved away to make the connection. For example, plumbing may be of such a nature that it is not straight. It may be turned at an angle of 180 degrees for both the mobile part 1 and complimentary part 2. In such a scenario, the plumbing outlets, the fluid exchange means 7, or parts thereof, may open towards the mobile part 1 or complimentary part 2 respectively. In other words, the plumbing or outlet 23 emerging from the mobile part 1 may be turned or bent through 180 degrees so that its open end is facing towards the mobile part 1 and not away. The same would hold for the complimentary part 2 and its outlet 22. It should be noted that the angle is only exemplary and may be varied according to requirements of the utility. Therefore, aligning and pulling the mobile part 1 away from the complimentary part 2 will achieve a fluid connection between the mobile part 1 and complimentary part 2. In an alternate embodiment, the mobile part 1 may swivel or pivot and such angular motion in relation to the complimentary part 2 may effect a fluid connection to be made.

As shown in the drawings the complimentary part 2 may be plumbed in a wall 3 as shown in FIG. 1. Alternate embodiments of the complimentary part 2 may be a vehicle, large machinery, refinery, silo, storage, container, compressor, a device holding fluid, and the like. Also, the location of the mobile part 1 and complimentary part 2 may be reversed. In alternate embodiments of the present disclosure, the mobile part 1 and the complementary part 2 may be oriented in horizontal, vertical, staggered, or any other spatial orientation. In special circumstances, such as gravity reduced or gravity absent environments, spatial position may not matter at all and only a fluid connection would matter.

In an alternate embodiment, the mobile part 1 may have a movable thread or rotating part which may mesh with a complimentary threaded portion located on the complimentary part 2, such complimentary threaded portion configured to accept the movable thread or rotating part of the mobile part 1, located on the complimentary part 2. The movable thread, rotating part, or complimentary threaded portion on the complimentary part 2 may be driven by a motor to assist or facilitate a connection. Again, it should be appreciated that there may be more than one connection and connecting mechanisms in the mobile part 1 and or the complimentary part 2.

It may be desired that there be no leakage or loss of fluid before, during, and after a fluid connection is made between the mobile part 1 and complimentary part 2. One embodiment of the present disclosure, as shown in FIGS. 1, 3, 4, 5, 6, employs a valve 14 to prevent leakage or loss. The mobile part 1 fluid dispensing apparatus may use the valve 14 in conjunction with a fluid exchange means 7.

The structure and operation of the valve 14 can be understood in the following explanation. In this embodiment of the present disclosure, the mobile part 1 may have an outlet 23 extending from it as a means for fluid connection with the complimentary part 2. The complimentary part 2 may have an outlet 22 extending from it as well.

The outlet 23 of the mobile part 1 has an actuator 5 as shown in the FIGS. 1 and 2. The actuator 5 may not completely block the flow of fluid within the outlet 23. The outlet 22 of the complimentary part 2 has a plunger assembly which consists of either a flexible or rigid actuated 6 as shown in FIGS. 1, 4 and 5, and a support system to hold the actuated 6 in place. For example, the actuated 6 may be a wire 10. Alternate embodiments of wire 10 may be flexible wire, rigid rod, coiled structure, and the like. The outlet 22 of the complimentary part 2 may be plumbing bent at 90 degrees as shown in the FIGS. 1, 3, 4, 5, and 6. In alternate embodiments, the plumbing may be straight. The support system may simply be a series of eyelets 9 suspended within the lumen of the outlet 22 of the complimentary part 2. The support system may not completely block the flow of fluid within the outlet 22 of the complimentary part 2. One of the functions of the support system is to keep the longitudinal axis of wire 10 from shifting beyond an operable tolerance from the desired position of the longitudinal axis. The tolerance in the shift of the wire 10 of its longitudinal axis may be dependent on various factors such as flexibility of the material of wire 10 or the shape of the outlet 22 of the complimentary part 2. The actuated 6 may be in mechanical communication with the valve 14. This mechanical communication may be a welded joint, linkages, hydraulic systems, pneumatic systems, and the like, or a combination thereof. Any force acting on the actuated 6, such as a force in a direction parallel to the actuated 6, may be transmitted to the valve 14. Depending on the configuration of the actuator 5 and actuated 6, a force acting on the actuated 6 following a direction away from the mobile part 1 and towards the complimentary part 2, may cause the actuated 6 to push the valve 14 open, allowing fluid to flow through the supply 12. In the drawing, valve 14 is a simple valve as shown. This valve 14 may sit in a seat 11 and may have a spring 13. The spring 13 may keep the valve 14 closed. One skilled in the art may be able to configure the valve 14 in numerous ways without departing from the teachings of the present disclosure. When spring 13 exerts force on valve 14, valve 14 may be pushed against the seat 11 and valve 14 may stop the flow of fluid across the valve 14. The valve 14 may block the flow of fluid completely when it is closed as shown in FIG. 4. In FIG. 4, the actuator 5 is not in contact with the actuated 6. It is also shows in FIG. 4 that the fluid exchange means 7 is at a first position and already in contact with the fluid seal 33. Fluid seal 33 may be made of a flexible or pliable material. Fluid seal may be an oil seal, rubber ring, o-ring, or the kind The fluid seal 33 may form a leak proof seal between the fluid exchange means 7 and the complimentary part 2. This leak proof seal may be formed before the actuator 5 makes contact with the actuated 6. In this position of the actuated 6, the valve 14 may be closed, and the flow of fluid across the valve 14 may also be stopped. Thus, a leak proof seal as described above may be formed even before fluid begins to flow across the valve 14.

As shown in FIG. 5, the actuator 5 is in contact with the actuated 6. The fluid exchange means 7 is seen as sliding past the first position to a second position, all while the fluid seal 33 is still maintaining a leak proof seal between the fluid exchange means 7 and the complimentary part 2. When the actuated 6 is pushed or displaced towards the complimentary part 2, it may cause the valve 14 to open, as shown in FIG. 5, and may allow fluid to flow through the supply 12 and the outlet 22 of the complimentary part 2.

As discussed above, the fluid connection between the mobile part 1 and the complimentary part 2 may use a fluid seal 33 setup. This fluid seal 33 set up may be used alongside the valve 14 as described above. For example, when the mobile part 1 and the complimentary part 2 are brought closer, their respective outlets may be aligned and fitted together. The fluid connection can be so configured, say by adjusting the lengths of the plumbing and various parts of the mobile part 1 and complimentary part 2, so that the fluid seal fluid connection is achieved before the actuator 5 touches the actuated 6. The mobile part 1 and the complimentary part 2 may be brought further closer, causing the actuator 5 to touch and push the actuated 6, thereby causing the valve 14 to open, all while sliding along the fluid seal fluid connection. It will be appreciated by one skilled in the art that such a set up will create a leak free connection before fluid starts flowing through the connection.

Furthermore, when the mobile part 1 and the complimentary part 2 are moved away from each other, the actuator 5 will disengage from the actuated 6 before the fluid seal fluid connection is uncreated. Thus, the flow of fluid may have ceased before the fluid seal fluid connection is disconnected, in turn preventing any spillage or waste of fluid.

The mobile part 1 part may use a guidance system to assist in the movement of the mobile part 1 to facilitate a connection with the complimentary part 2. The guidance system may comprise of rails, channels, grooves, magnets, tethers, cords, ropes, chains, ducts, vessels, lumen, cavity, cones and tapers, holes and pins, mechanical systems, electromechanical systems, magnetic systems, optical systems, manual systems, and the like or a combination thereof. In one of the embodiments of the disclosure, the mobile part 1 may have sensor 17 and sensor 19, and the complimentary part 2 may have sensor 20 and sensor 21. All sensors may be of a single kind or may be of different kinds It should be appreciated that the sensors may be placed at any point on the mobile part 1 or complimentary part 2, so as to achieve the desired results. In alternate embodiments, a sensor may be an optical sensor, magnetic sensor, electronic sensor, aural sensor, transducer, mechanical sensor, electromechanical sensor, beacon, and the like. These sensors may use electronics to show alignment. For example, when sensor 17 and 20 are lined up, a sound may be emitted, and when sensors 19 and 21 are lined up, another sound may be emitted. These sensors may be situated in such a way that they would line up only when the outlet 23 of the mobile part 1 and the outlet 22 of the complimentary part 2 are aligned for connection. Thus, a user will know that the parts are aligned for making a fluid connection between the mobile part 1 and complimentary part 2. The mobile part 1 part may travel along rails, channels, grooves, magnets, tethers, cords, ropes, chains, ducts, vessels, lumen, cavity, cones and tapers, holes and pins, or any other structure so as to use such structure as a total or partial guidance system. Guidance systems need not be limited to mechanical structures. Aural, tactile and optical systems may be used. Optical systems may employ exclusively, or in combination, visible, invisible, infrared, ultraviolet light. Optical systems may utilize lasers, plane polarized light, diffused or a combination of light sources. Some systems may use diffused light for rough guidance and lasers for fine tuning Hydraulic or pneumatic systems may also be employed in guidance systems.

Optical systems may be used in special circumstances such as gravity reduced or zero gravity situations. A light source may be used as a beacon at either the mobile part 1 or complimentary part 2. If a mobile part 1 uses a beacon, the complementary part 2 may employ a sensor 20 which will guide a mechanism which will bring the mobile part 1 and complimentary part 2 together. If the complimentary part 2 uses a beacon, the mobile part 1 may employ a sensor 17 which may guide a mechanism to bring the mobile part 1 and complimentary part 2 together. Optical systems may use optical mapping of light sources along annular rings or along lines and the information can be deciphered by electronic systems to activate movement of the mobile part 1. For example, an optical system on the mobile part 1 part may have several light rays scanning a marked plate on the complimentary part 2. The scanned information may be interpreted to indicate to the guidance or propelling systems of mobile part 1, such as servo motor driven wheels, which way to turn.

Aural systems may use sensors which will emit sounds when alignment is achieved. The sound may vary frequency to indicate the degree of alignment. For example, a lower frequency for a lower degree of alignment and a higher frequency once a higher degree of alignment, and then a distinct beep once perfect alignment is achieved. The sounds emitted may not be loud at all, nor may be heard over large distances. The sound may be transmitted over a radio device, remote device, or a wireless device such as a wireless earpiece device. It should be appreciated that an aural system may be used by the vision impaired. Persons working in situations where no lights can be used may also benefit from embodiments as described in the present disclosure. All these procedures may be manual or automated.

The mobile part 1 part may travel along a track 15 as shown in FIG. 1. Track 15 may be one or more tracks, and may be situated at one or more locations on the mobile part 1. Alternate embodiments of the track 15 may be one or more tracks, rails, channels, grooves, magnets, tethers, cords, ropes, chains, ducts, vessels, lumen, cavity, cones and tapers, holes and pins, and the like. The wheel 27 may be situated in track 15, as shown in FIGS. 2, 7 and 8, for limiting the movement of the mobile part 1 in a particular direction. The mobile part may have a second cavity 30 for housing a mechanical drive 28. The wheel 27 may be driven by the mechanical drive 28 as depicted in FIGS. 2 and 8. If a mechanical system for guidance, such as track 15, is employed, it will be appreciated by one skilled in the art that the mobile part 1 may be propelled by mechanical drive within the mobile part 1 or on the track 15. Alternate embodiments of the mechanical drive 28 may be an electric motor, gears situated within the mobile part 1 which may mesh with cross members along the track 15, one or more rotating members such as a wheel 27 which may abut against a surface of a track 15 and propel the mobile part 1 by friction, much like the action of a car tire along the surface of the road, other embodiments of the mechanical drive 28 may be rack and pinion, screw and nut assembly, screw and thread assembly, rockets, magnets, and the like. The mechanical drive 28 may also be equipped with a braking system. A person skilled in the art may come up with a plurality of methods for achieving the desired movement of the mobile part 1.

Once the mobile part 1 and the complimentary part 2 achieve a fluid connection, it may be desirable to lock them in position. The mobile part 1 and the complimentary part 2 may have linkages 24 and 25, respectively, with holes 26 in them. The linkages and holes may be aligned and a locking pin may be inserted in them to lock the mobile part 1 and complimentary part 2. Alternative embodiments of linkages may be fasteners, hooks, magnets, locking pins, and the like.

Although certain embodiments of the present disclosure will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present disclosure are illustrated in detail in the accompanying drawings, wherein like reference numerals refer to like elements throughout the drawings.

What is claimed is:

1. A mobile fluid dispensing apparatus comprising:
a mobile part having a fluid exchange means for facilitating a fluid connection between the mobile part and a complimentary part, wherein the mobile part includes an actuator for actuating an actuated of the complimentary part;
wherein the fluid connection is established when the mobile part engages the complimentary part through movement of the mobile part in relation to the complimentary part;
wherein once the fluid connection is established, the actuator is moved from a first position to a second position to move a valve of the complimentary part from a closed position to an open position to allow a flow of fluid through the mobile part.

2. The mobile fluid dispensing apparatus of claim 1, wherein the mobile part has a dispensing means for dispensing a material exchanged through the fluid connection.

3. The mobile fluid dispensing apparatus of claim 2, wherein the dispensing means is a faucet.

4. The mobile fluid dispensing apparatus of claim 1, wherein the mobile part has at least one wheel.

5. The mobile fluid dispensing apparatus of claim 1, wherein the mobile part has at least one cavity.

6. The mobile fluid dispensing apparatus of claim 1, wherein the complimentary part has at least one sensor.

7. The mobile fluid dispensing apparatus of claim 5, wherein the sensor is selected from a group consisting of: electromechanical sensor, optical sensor, magnetic sensor, transducer, aural sensor, mechanical sensor, and electronic sensor.

8. The mobile fluid dispensing apparatus of claim 1, wherein the mobile part has a guidance system.

9. The mobile fluid dispensing apparatus of claim 8, wherein the guidance system is selected from a group consisting of: optical guidance system, magnetic guidance system, transducer, aural guidance system, mechanical guidance system, and electronic guidance system.

10. The mobile fluid dispensing apparatus of claim 1, wherein the mobile part is a portable cleaning station.

11. The mobile fluid dispensing apparatus of claim 1, wherein the fluid connection has at least one fluid seal.

12. The mobile fluid dispensing apparatus of claim 1, wherein the mobile part has at least one sensor.

13. The mobile fluid dispensing apparatus of claim 1, wherein the mobile part has a locking system.

14. The mobile fluid dispensing apparatus of claim 3, wherein the cavity is a washing area.

15. The mobile fluid dispensing apparatus of claim 1, wherein the complimentary part has a locking system.

16. The mobile fluid dispensing apparatus of claim 1, wherein the mobile part has a braking system.

17. A method of dispensing fluid with a mobile fluid dispensing apparatus comprising:
providing a mobile part, a complimentary part, and a fluid exchange means for facilitating a fluid connection between the mobile part and the complimentary part; and
engaging the mobile part with the complimentary part to form a fluid connection between the mobile part and the complimentary part through movement of the mobile part in relation to the complimentary part.

18. A mobile fluid dispensing system comprising:
a mobile part;
a complimentary part; and
a fluid exchange means for facilitating a fluid connection between the mobile part and the complimentary part;
wherein the fluid connection is established when the mobile part engages the complimentary part through movement of the mobile part in relation to the complimentary part.

19. The mobile fluid dispensing apparatus of claim 1, wherein said mobile part has a drain apparatus.

20. The mobile fluid dispensing apparatus of claim 1, wherein the mobile part has at least one heat source.
